(19) United States
(12) Patent Application Publication
(10) Pub. No.: US 2026/0253202 A1
(43) Pub. Date: Aug. 27, 2026

(54) SECONDARY BATTERY INSPECTION APPARATUS AND SECONDARY BATTERY INSPECTION METHOD

(71) Applicant: SAMSUNG SDI CO., LTD., Yongin-si (KR)

(72) Inventor: Jiwon YUN, Yongin-si (KR)

(21) Appl. No.: 19/074,687

(22) Filed: Mar. 10, 2025

(30) Foreign Application Priority Data
Oct. 24, 2024 (KR) 10-2024-0146699

(51) Int. Cl. G06T 7/00; G06T 7/62; G06T 7/73; H01M 10/42

(52) U.S. Cl. CPC G06T 7/001; G06T 7/62; G06T 7/74; H01M 10/4285; G06T 2207/30108; G06T 2207/30204

(57) ABSTRACT

An apparatus for inspecting a secondary battery, the apparatus including an imaging unit to generate an image of a surface of a cap assembly to which an electrode tab of the secondary battery is bonded, resulting in a generated image, and a processor to determine a bonding state of the electrode tab to the cap assembly based on the generated image, resulting in a determined bonding state, wherein the processor sets one or more imaginary reference lines on the cap assembly in the generated image, sets an imaginary extension line extending from the electrode tab in the generated image, and determines whether the secondary battery is acceptable or defective based on the determined bonding state using the one or more imaginary reference lines and the imaginary extension line.

### CROSS-REFERENCE TO RELATED APPLICATION

This application claims priority under 35 U.S.C § 119 to Korean Patent Application No. 10-2024-0146699, filed in the Korean Intellectual Property Office on Oct. 24, 2024, the entire contents of which are hereby incorporated by reference.

### BACKGROUND

### 1. Field

Embodiments of the present disclosure relate a secondary battery inspection apparatus and a secondary battery inspection method.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Embodiments include an apparatus for inspecting a secondary battery, the apparatus including an imaging unit configured to generate an image of a surface of a cap assembly to which an electrode tab of the secondary battery is bonded, resulting in a generated image, and a processor configured to determine a bonding state of the electrode tab to the cap assembly based on the generated image, resulting in a determined bonding state, wherein the processor is configured to set one or more imaginary reference lines on the cap assembly in the generated image, set an imaginary extension line extending from the electrode tab in the generated image, and determine whether the secondary battery is acceptable or defective based on the determined bonding state using the one or more imaginary reference lines and the imaginary extension line.

The cap assembly may include a terminal plate or a cap plate including a plurality of markers at a peripheral edge of the cap plate, and the processor may be configured to set an imaginary center point on the cap assembly based on the plurality of markers.

The processor may be further configured to set a first reference line perpendicular to a folding direction of the cap assembly, the first reference line passing through the imaginary center point, and set a second reference line parallel to the folding direction of the cap assembly and perpendicular to the first reference line, the second reference line passing through the imaginary center point.

The processor may be configured to calculate an angle between the imaginary extension line and the second reference line, determine the secondary battery as acceptable if the calculated angle is less than or equal to a first threshold value, and determine the secondary battery as defective if the calculated angle exceeds the first threshold value.

The processor may be configured to calculate a distance between the imaginary center point and an intersection of the imaginary extension line and the first reference line, resulting in a calculated distance, determine the secondary battery as acceptable if the calculated distance is less than or equal to a second threshold value, and determine the secondary battery as defective if the calculated distance exceeds the second threshold value.

The processor may be configured to calculate an angle between the imaginary extension line and the second reference line, resulting in a calculated angle, calculate a distance between the imaginary center point and an intersection of the imaginary extension line and the first reference line, resulting in a calculated distance, determine the secondary battery as acceptable if the calculated angle is less than or equal to a first threshold value and the calculated distance is less than or equal to a second threshold value, and determine the secondary battery as defective if the calculated angle exceeds the first threshold value or the calculated distance exceeds the second threshold value.

The processor may be configured to calculate a shortest distance between the imaginary extension line and the imaginary center point, resulting in a calculated shortest distance, determine the secondary battery as acceptable if the calculated shortest distance is less than or equal to a third threshold value, and determine the secondary battery as defective if the calculated shortest distance exceeds the third threshold value.

The processor may be further configured to detect at least two outlines on the electrode tab included in the generated image, and set the imaginary extension line as a centerline of the at least two outlines.

The plurality of markers may include two markers at diametrically opposite edges of the terminal plate or the cap plate.

The plurality of markers may be on a surface of the terminal plate or a surface of the cap plate that has been laser irradiated.

Embodiments include a method for inspecting a secondary battery, the method including obtaining, by an imaging unit, an image of a surface of a cap assembly to which an electrode tab of the secondary battery is bonded, setting, by a processor, one or more imaginary reference lines on the cap assembly included in the image, setting, by the processor, an imaginary extension line extending from the electrode tab included in the image, and determining, by the processor, whether the secondary battery is acceptable or defective based on a bonding state determined, by the processor, using the one or more imaginary reference lines and the imaginary extension line.

The cap assembly may include a terminal plate or a cap plate including a plurality of markers formed at a peripheral edge of the cap plate, and the method may further include setting, by the processor, an imaginary center point on the cap assembly based on the plurality of markers.

Setting one or more imaginary reference lines may include setting, by the processor, a first reference line that is perpendicular to a folding direction of the cap assembly and passes through the imaginary center point, and setting, by the processor, a second reference line that is parallel to the folding direction of the cap assembly and perpendicular to the first reference line, the second reference line passing through the imaginary center point.

Determining whether the secondary battery is acceptable or defective may include calculating, by the processor, an angle between the imaginary extension line and the second reference line, resulting in a calculated angle, determining, by the processor, the secondary battery as acceptable if the calculated angle is less than or equal to a first threshold value, and determining, by the processor, the secondary battery as defective if the calculated angle exceeds the first threshold value.

Determining whether the secondary battery is acceptable or defective may include calculating, by the processor, a distance between the imaginary center point and an intersection of the imaginary extension line and the first reference line, resulting in a calculated distance, determining, by the processor, the secondary battery as acceptable if the calculated distance is less than or equal to a second threshold value, and determining, by the processor, the secondary battery as defective if the calculated distance exceeds the second threshold value.

Determining whether the secondary battery is acceptable or defective may include calculating, by the processor, an angle formed between the imaginary extension line and the second reference line, resulting in a calculated angle, calculating, by the processor, a distance between the imaginary center point and an intersection of the imaginary extension line and the first reference line, resulting in a calculated distance, determining, by the processor, the secondary battery as acceptable if the calculated angle is less than or equal to a first threshold value and the calculated distance is less than or equal to a second threshold value, and determining, by the processor, the secondary battery as defective if the calculated angle exceeds the first threshold value or the calculated distance exceeds the second threshold value.

Determining whether the secondary battery is acceptable or defective may include calculating, by the processor, a shortest distance between the imaginary extension line and the imaginary center point, resulting in a calculated shortest distance, determining, by the processor, the secondary battery as acceptable if the calculated shortest distance is less than or equal to a third threshold value, and determining, by the processor, the secondary battery as defective if the calculated shortest distance exceeds the third threshold value.

Setting the imaginary extension line may include detecting, by the processor, at least two outlines on the electrode tab included in the image, and setting, by the processor, the imaginary extension line being a centerline of the at least two outlines.

The plurality of markers may include two markers formed at diametrically opposite edges of the terminal plate or the cap plate.

The plurality of markers may be formed on a surface of the terminal plate or a surface of the cap plate by a laser irradiation device.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

Features will become apparent to those of ordinary skill in the art by describing in detail exemplary embodiments with reference to the attached drawings, in which:

FIG. 1 illustrates a perspective view of a secondary battery according to one or more embodiments of the present disclosure;

FIG. 2 illustrates an exploded perspective view of a secondary battery according to one or more embodiments of the present disclosure;

FIG. 3 illustrates an example of the secondary battery having an upper surface that is open before the cap assembly is joined to the case according to one or more embodiments of the present disclosure;

FIG. 4 illustrates a schematic view of an apparatus for inspecting a secondary battery (hereinafter referred to as “inspection apparatus”) according to one or more embodiments of the present disclosure;

FIG. 5 illustrates an example of a cap plate 13 with a marker 13′ formed thereon according to one or more embodiments of the present disclosure;

FIG. 6 illustrates an example of a reference line (baseline) and a marking line virtually formed by the processor based on an image captured by the imaging unit, according to one or more embodiments of the present disclosure;

FIG. 7 illustrates an example of the electrode tab in which an extension line is formed to extend through the center of the electrode tab 30 based on a plurality of outlines according to one or more embodiments of the present disclosure;

FIG. 8 illustrates an example of a bonding state of the electrode tab, which is determined to be acceptable, according to one or more embodiments of the present disclosure;

FIG. 9 illustrates an example of a state in which the electrode tab is bonded and tilted by an angle of a first threshold value according to one or more embodiments of the present disclosure;

FIG. 10 illustrates an example of a state in which the electrode tab is bonded while the extension line and the first reference line are spaced apart from each other by a second threshold value, according to one or more embodiments of the present disclosure;

FIG. 11 illustrates an example of a state in which the electrode tab is tilted by an angle of a first threshold value, and the shortest distance between the extension line and the center point is equal to a third threshold value, according to one or more embodiments of the present disclosure;

FIG. 12 illustrates a flowchart of a method for inspecting a secondary battery according to one or more embodiments of the present disclosure; and

FIG. 13 illustrates a flowchart of detailed sub-steps of a step of determining whether the secondary battery is acceptable or defective according to one or more embodiments of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her embodiments in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in this specification are intended to describe embodiments of the present disclosure and are not intended to limit the present disclosure.

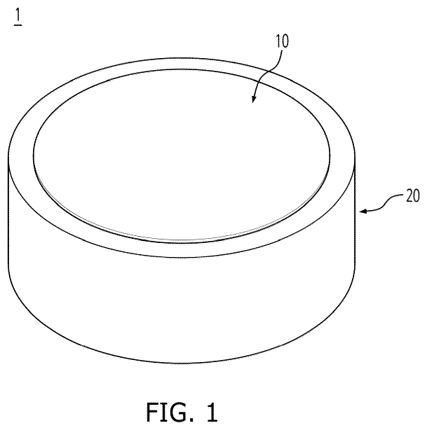

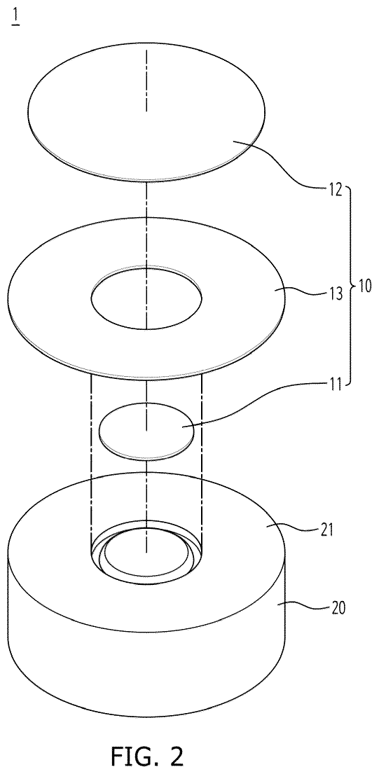

FIG. 1 illustrates a perspective view of a secondary battery according to one or more embodiments of the present disclosure. FIG. 2 illustrates an exploded perspective view of a secondary battery according to one or more embodiments of the present disclosure.

In one or more embodiments, a secondary battery 1 may be a coin cell or a button cell. However, the secondary battery 1 may also be a cylindrical cell or a pin-type cell.

The coin cell or the button cell may be a battery in the form of a thin coin or button and may refer to a battery having a ratio of height to diameter (height/diameter) of 1 or less, but the ratio may vary. As the coin cell or the button cell is generally cylindrical, the cross section in the horizontal direction is generally circular. However, the cross section in the horizontal direction may have an elliptical or polygonal shape. The diameter may refer to a maximum distance in the horizontal direction of the battery, and the height may refer to a maximum distance in the vertical direction of the battery (e.g., distance from the flat bottom surface to the flat top surface of the battery).

Referring to FIGS. 1 and 2, the secondary battery 1 according to one or more embodiments of the present disclosure may include an electrode assembly 21, a case 20, and a cap assembly 10.

The electrode assembly 21 may include a first electrode, a second electrode, a separator, a first electrode tab connected to the first electrode, and a second electrode tab connected to the second electrode. Here, the first electrode may serve as a negative electrode, and the second electrode may serve as a positive electrode. However, the reverse configuration is also possible. For example, the electrode assembly 21 may be a winding-type electrode assembly formed by interposing the separator, which is an insulator, between the first electrode and the second electrode and then winding them together. However, the type of electrode assembly may vary.

In one or more embodiments, the first electrode may include a coated portion that is a region where an active material is applied to both surfaces (opposite surfaces) of a first substrate formed of a thin metal plate, and an uncoated portion that is a region where the active material is not applied, exposing the first substrate. The first electrode may include uncoated portions formed on both end portions (opposite end portions) of the first substrate in a longitudinal direction along which the first electrode is wound. The first electrode may form the negative electrode by coating a metal substrate, such as copper, a copper alloy, nickel, or a nickel alloy, with a negative electrode active material such as graphite or carbon.

In one or more embodiments, the second electrode may include a coated portion that is a region where an active material is applied to both sides (opposite surfaces) of a second substrate formed of a thin metal plate, and an uncoated portion that is a region where the active material is not applied, exposing the second substrate. The second electrode may include uncoated portions formed on both end portions (opposite end portions) of the second substrate in a longitudinal direction along which the second electrode is wound. The second electrode may form the positive electrode by coating a metal substrate, such as aluminum or an aluminum alloy, with a positive electrode active material such as a transition metal oxide.

In one or more embodiments, the separator may be disposed between the first electrode and the second electrode. The separator is configured to insulate the first electrode from the second electrode while allowing lithium ions to be exchanged between the first electrode and the second electrode. The separator may have a sufficient length to ensure complete insulation between the first electrode and the second electrode, even when the electrode assembly 21 undergoes contraction or expansion during the charging and discharging processes of the secondary battery 1.

The first electrode tab may be disposed on an outer surface of the electrode assembly 21. The first electrode tab may be separately formed and connected to the uncoated portion of the first electrode or may be formed by punching out a part of the uncoated portion.

Here, between the electrode tabs extending from the first and second electrodes, the electrode tab connected to the first electrode may be connected to the case 20, while the electrode tab connected to the second electrode may be connected to the cap assembly 10. Specifically, as an example, the electrode tab connected to the cap assembly 10 may be disposed on the outer surface of the electrode assembly 21 and electrically connected to a terminal 11, which protrudes downward from a terminal plate 12 through a central hole of the cap plate 13. Such an electrode tab may be connected to the uncoated portion or formed by punching out a part of the uncoated portion.

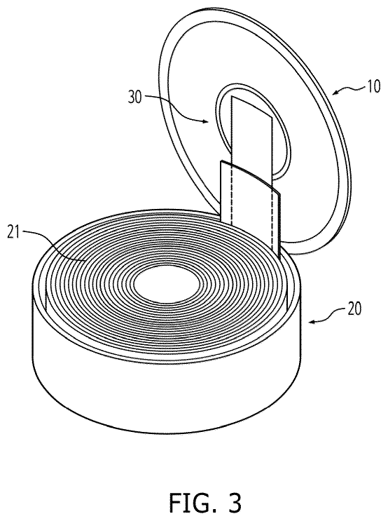

The electrode tab of the second electrode may be connected to the cap assembly 10. The electrode tab of the second electrode may be joined to the cap assembly 10 and folded over an upper surface of the electrode assembly 21 (see FIG. 3). Thus, the electrode tab of the second electrode may be folded and connected to the terminal plate 12, which is an inner surface of the cap assembly 10. The second electrode and the cap assembly 10 may be electrically connected through the electrode tab of the second electrode.

The cap plate 13 may include an opening formed at the central portion thereof and may contact the open side of the case 20. The cap plate 13 may be seated on a sidewall portion of the case 20 and joined to the case 20. The cap plate 13 may have a disc shape configuration, within the opening formed at its center and an outer edge portion surrounding the opening that corresponds to the shape of the case 20.

The terminal plate 12 may be disposed to cover the cap plate 13 and seal the electrode assembly 21. The terminal 11, corresponding to a protrusion of the terminal plate 12, may extend through the opening of the cap plate 13 to be connected to the electrode tab of the electrode assembly 21. An insulating layer may be disposed between the terminal plate 12 and the cap plate 13, allowing the terminal plate 12 and the cap plate 13 to be electrically insulated from each other. The terminal plate 12 may be connected to the second electrode through the electrode tab and may serve as the positive electrode. The terminal plate 12 may be disposed as an uppermost layer of the cap assembly 10 and may be connected to an external terminal for interfacing with a load.

FIG. 3 illustrates an example of the secondary battery 1 having an upper surface that is open before the cap assembly 10 is joined to the case 20 according to one or more embodiments of the present disclosure.

Referring to FIG. 3, the electrode tab 30 of the second electrode may be electrically connected to the terminal plate 12 positioned on the inner surface of the cap assembly 10. The electrical connection may be established through bonding methods such as laser welding. In this configuration, the electrode tab 30 may be aligned with and bonded to the central portion of the cap assembly 10. Following the bonding process, the electrode tab 30 may be folded toward the case 20, and the cap assembly 10 may be joined to the case 20 through bonding methods such as laser welding, thereby sealing the interior of the secondary battery 1.

In a case where the electrode tab 30 is bonded to the cap assembly 10 while the electrode tab 30 is not properly aligned with the cap assembly 10, the folding direction of the electrode tab 30 may deviate, resulting in a reduction in tensile strength and also leading to decreased durability of the secondary battery 1. A secondary battery inspection apparatus according to one or more embodiments of the present disclosure is provided to inspect a bonding state of the electrode tab 30, thereby enabling the manufactured secondary battery 1 to be classified as acceptable or defective.

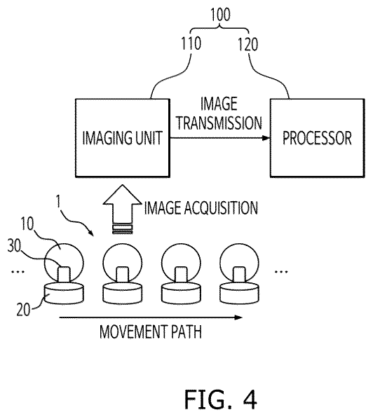

FIG. 4 illustrates a schematic view of an apparatus 100 for inspecting a secondary battery (hereinafter referred to as “inspection apparatus”) according to one or more embodiments of the present disclosure.

Referring to FIG. 4, the inspection apparatus 100 according to one or more embodiments of the present disclosure may include an imaging unit 110 configured to capture an image of one surface of the cap assembly 10 to which the electrode tab 30 of the secondary battery 1 is bonded, and a processor 120 configured to determine a bonding state of the electrode tab 30 on the cap assembly 10 based on the image generated by the imaging unit 110. The processor 120 may set one or more imaginary reference lines (baselines) on the cap assembly 10 included in the image, set an imaginary extension line extending from the electrode tab 30 included in the image, and determine the bonding state of the electrode tab 30 based on the one or more reference lines and the extension line to thereby determine whether the secondary battery is acceptable or defective.

Specifically, the secondary battery 1 may include the cap assembly 10 connected to the electrode tab 30, and the case 20, and the cap assembly 10 may be arranged in an open state relative to the case 20. For example, a plurality of secondary batteries 1 may be arranged at predetermined intervals on a conveyor belt and may be transported along a predetermined movement path. The imaging unit 110 of the inspection apparatus 100 may be disposed in the movement path, and the imaging unit 110 may capture images of imaging areas as the plurality of secondary batteries 1 pass through the imaging areas.

The captured image may include the inner surface of the cap assembly 10, which is the surface where the cap assembly 10 and the electrode tab 30 are bonded. However, the captured image may include the outer surface of the cap assembly 10. After capturing the inner surface of the cap assembly 10, the generated image may be transmitted to the processor 120. The processor 120 may establish pieces of criterion for the received image including the setting of imaginary baselines on the received image, and the processor 120 may determine the secondary battery to be acceptable if the criterion is satisfied and determine the secondary battery to be defective if the criterion is not satisfied.

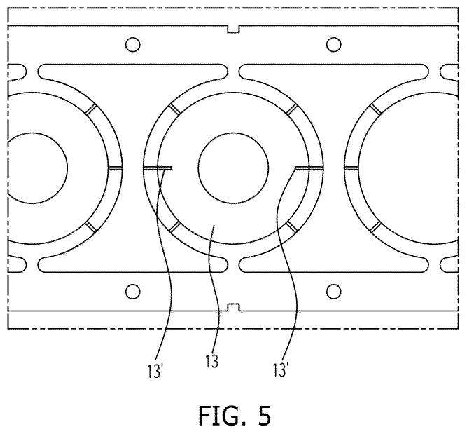

FIG. 5 illustrates an example of a cap plate 13 with a marker 13′ formed thereon according to one or more embodiments of the present disclosure.

Referring to FIG. 5, in one or more embodiments of the present disclosure, the marker 13′ may be formed on the cap plate 13 to provide a criterion for inspecting an alignment state between the electrode tab 30 and the cap assembly 10. The marker 13′ may not be formed virtually but is physically marked on a surface of the cap plate 13 through physical means. For example, the marker 13′ may be formed on the surface of the cap plate 13 by a laser irradiation device. For example, the marker 13′ may be provided at a peripheral edge of the cap plate 13 in the radial direction. A plurality of markers 13′ may be formed, and the number of markers 13′ may be two or may be more than two. For example, in a case where two markers 13′ are provided, they may be arranged at 180-degree intervals, as shown in FIG. 5 (for example, two markers 13′ may be provided at diametrically opposite edges of the cap plate 13). In another example, in a case where three markers 13′ are provided, they may be arranged at 120-degree intervals.

In another embodiment, the marker 13′ may be formed on the terminal plate 12. In a case where the marker 13′ is formed on the terminal plate 12, the marker 13′ may also be provided at a peripheral edge of the terminal plate 12 in the radial direction by the laser irradiation device (for example, in a case where two markers 13′ are formed on the terminal plate 12, the two markers 13′ are provided at diametrically opposite edges of the terminal plate 13).

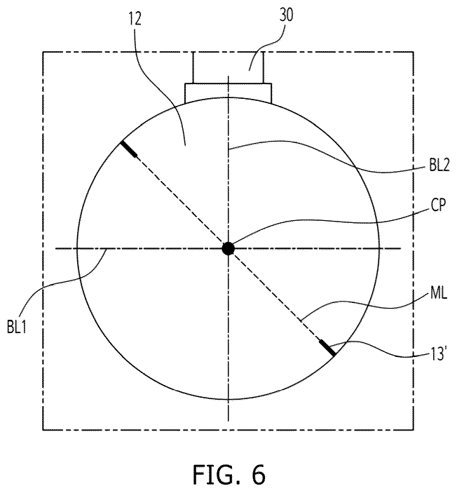

FIG. 6 illustrates an example of a reference line (baseline) and a marking line ML virtually formed by the processor 120 based on an image captured by the imaging unit 110, according to one or more embodiments of the present disclosure.

Referring to FIG. 6, as described above, a straight line connecting the two opposite markers 13′ may correspond to the diameter of the terminal plate 12 or the cap plate. The terminal plate 12 may be configured in electrical connection with the electrode tab 30 and, thus, the terminal plate 12 is arranged such that a center point CP thereof aligns with (overlaps with) a center point CP of the cap plate. Therefore, the center point CP of the terminal plate 12 or the cap plate may coincide with a center point CP of the cap assembly 10.

For example, the processor 120 may form a marking line ML, which is an imaginary line connecting a pair of markers 13′ formed at diametrically opposite edges of the terminal plate 12 or the cap plate, respectively. An extended section of the marking line ML corresponds to the diameter of the terminal plate 12 or the cap plate. Therefore, a distance from a midpoint of the marking line ML to one marker 13′ may represent the radius from the center point CP. For example, the processor 120 may calculate a position of the center point CP of the terminal plate 12 or the cap plate by forming the imaginary line based on the markers 13′.

The calculated center point CP may be utilized by the processor 120 to virtually establish reference lines, each serving as a baseline for folding the cap assembly 10 toward the case 20. For example, two orthogonal lines passing through the center point CP may be defined. Specifically, the reference lines may include a first reference line (first baseline) BL1 and a second reference line (second baseline) BL2. The first reference line BL1 may be perpendicular to the folding direction of the cap assembly 10 and pass through the center point CP. The second reference line BL2 may be parallel to the folding direction of the cap assembly and perpendicular to the first reference line BL1 and also pass through the center point CP. In one or more embodiments, the second reference line BL2 may be aligned with the folding direction of the cap assembly 10 and serve as a baseline for inspecting (examining) an angle of the electrode tab 30 among pieces of the criterion for inspecting the alignment of the electrode tab 40 to the cap assembly 10. In one or more embodiments, the first reference line BL1 may serve as a baseline for inspecting (examining) a separation distance between the center point CP and the center of the electrode tab 30 among pieces of the criterion for inspecting the alignment of the electrode tab 40 to the cap assembly 10. Additionally, a line generated from the electrode tab 30 for comparison with the reference lines may also be created by the processor 120.

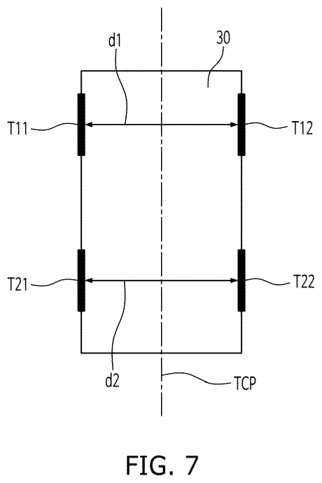

FIG. 7 illustrates an example of the electrode tab 30 in which an extension line TCP is formed to extend through the center of the electrode tab 30 based on a plurality of outlines T11, T12, T21, and T22, according to one or more embodiments of the present disclosure.

Referring to FIG. 7, the processor 120 may detect at least two outlines (e.g., portions of or along edges) on the electrode tab 30 included in the image and establish an imaginary extension line TCP that is a centerline of the two outlines. For example, on two opposite outlines in the width direction of the electrode tab 30, arbitrary opposite lines may be formed in pairs, one at the top and one at the bottom. The extension line TCP may be defined as a line that extends toward the cap assembly 10, connecting an arbitrary line formed at the midpoint of a first interval d1 that is a distance between a first-1 outline T11 and a first-2 outline T12 at the top, and an arbitrary line formed at the midpoint of a second interval d2 that is a distance between the second-1 outline T21 and the second-2 outline T22 at the bottom. For example, the arbitrary lines may be replaced by arbitrary points, in which case the arbitrary points respectively formed at the midpoint of the interval d1 and the midpoint of the interval d2 may be connected to each other.

As described with reference to FIG. 6, the processor 120 may measure a bonding angle between the electrode tab 30 and the cap assembly 10 by comparing the extension line with the second reference line BL2. Additionally, the processor 120 may measure a separation distance from the center point CP along the first reference line BL1 using the extension line and the first reference line BL1. These comparisons and measurements enables the classification of acceptable and defective secondary batteries.

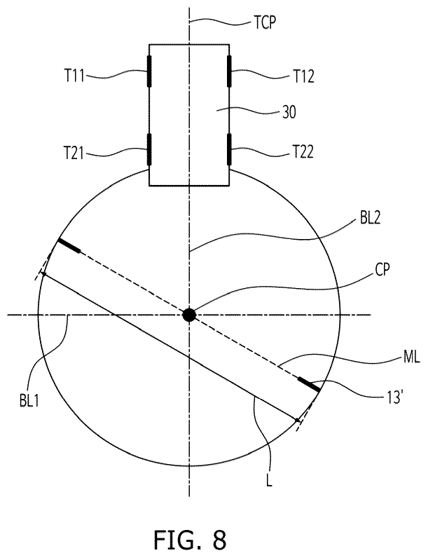

FIG. 8 illustrates an example of a bonding state of the electrode tab 30, which is determined to be acceptable, according to one or more embodiments of the present disclosure.

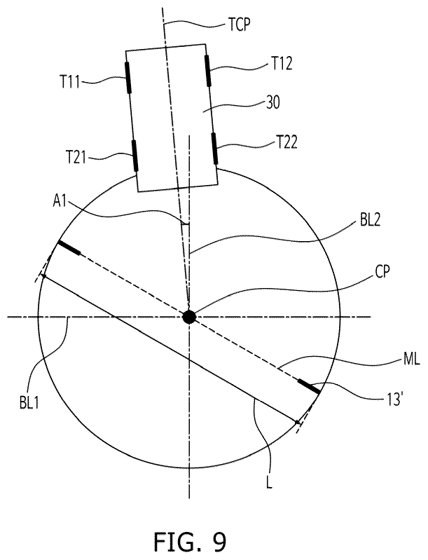

Referring to FIG. 8, as an example of a desirable acceptable bonding state, the extension line TCP formed from the electrode tab 30 by the processor 120 may extend in alignment with the second reference line BL2 and pass through the center point CP, which is located at the midpoint of the marker interval L that is the distance between the markers. The extension line TCP formed in such a manner may indicate that the electrode tab 30 and the cap assembly 10 are properly aligned. Specifically, the extension line TCP may not exhibit an angular deviation from the second reference line BL2 and may have no separation distance from the center point CP along the first reference line BL1. Additionally, the processor 120 may determine the bonding state to be acceptable if a position of the extension line TCP relative to each reference line falls within a margin of error that does not exceed a predefined threshold. For example, the bonding state may be determined to be acceptable (i.e., the secondary battery may be classified as acceptable) if the angular deviation from the second reference line BL2 is within the margin of error and/or the distance between the center point CP and the intersection of the first reference line BL1 and the extension line TCP is within the margin of error. Examples of the bonding state that is determined to be defective will be described in detail with reference to FIGS. 9 to 11.

FIG. 9 illustrates an example of a state in which the electrode tab 30 is bonded and tilted by an angle of a first threshold value according to one or more embodiments of the present disclosure.

Referring to FIG. 9, the processor 120 may calculate an angle A1 formed between the extension line TCP and the second reference line BL2. Then, if the calculated angle A1 is less than or equal to the first threshold value, the secondary battery 1 may be determined to be acceptable. In some embodiments, if the calculated angle A1 exceeds the first threshold value, the secondary battery 1 may be determined to be defective.

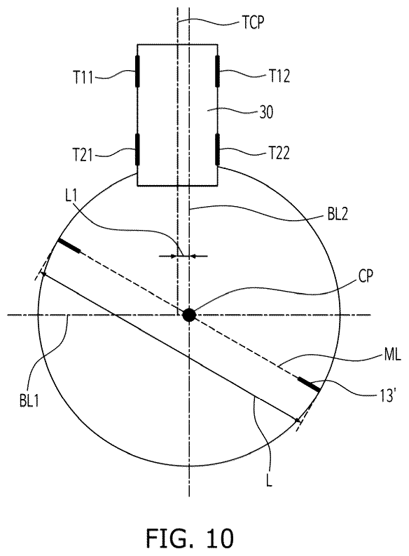

FIG. 10 illustrates an example of a state in which the electrode tab 30 is bonded while the extension line TCP and the first reference line BL1 are spaced apart from each other by a second threshold value L1, according to one or more embodiments of the present disclosure.

Referring to FIG. 10, the processor 120 may calculate a distance between the center point CP and the intersection of the extension line TCP and the first reference line BL1. Then, if the calculated distance is less than or equal to the second threshold value, the secondary battery 1 may be determined to be acceptable. In some embodiments, if the calculated distance L1 exceeds the second threshold value, the secondary battery 1 may be determined to be defective.

In one or more embodiments, the processor 120 may calculate the angle formed between the extension line TCP and the second reference line BL2 and the distance between the center point CP and the intersection of the extension line TCP and the first reference line BL1. If the calculated angle is less than or equal to the first threshold value and the calculated distance is less than or equal to the second threshold value, the processor 120 may determine the secondary battery 1 to be acceptable. In some embodiments, if the calculated angle exceeds the first threshold value or the calculated distance exceeds the second threshold value, the processor 120 may determine the secondary battery 1 to be defective. In this case, the processor 120 may classify the secondary battery 1 as acceptable only if the angle formed between the extension line TCP and the second reference line BL2 lies within a predetermined range and, at the same time, the intersection of the extension line TCP and the first reference line BL1 lies within a predetermined distance from the center point CP.

In another embodiment, the processor 120 may determine the secondary battery 1 to be acceptable if the calculated angle is less than or equal to the first threshold value or the calculated distance is less than or equal to the second threshold value. In some embodiments, if the calculated angle exceeds the first threshold value and the calculated distance exceeds the second threshold value, the processor 120 may determine the secondary battery 1 to be defective. In this case, the processor 120 may classify the secondary battery 1 as acceptable if either the angle that is formed between the extension line TCP and the second reference line BL2 is within a predetermined range, or the intersection of the extension line TCP and the first reference line BL1 lies within a predetermined distance from the center point CP.

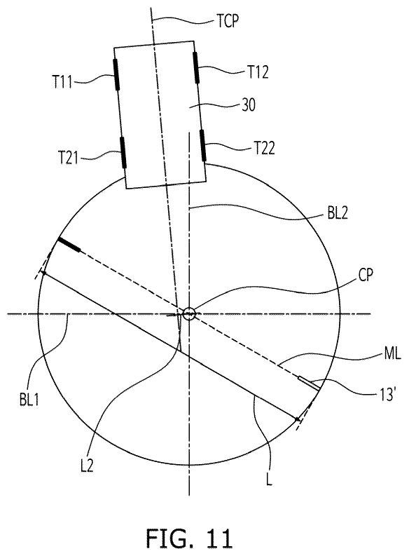

FIG. 11 illustrates an example of a state in which the electrode tab 30 is tilted by an angle of a first threshold value, and the shortest distance between the extension line TCP and the center point CP is equal to a third threshold value L2, according to one or more embodiments of the present disclosure.

Referring to FIG. 11, the processor 120 may calculate a distance (i.e., the shortest distance) L2 between the extension line TCP and the center point CP. Then, if the calculated distance L2 is less than or equal to the third threshold value, the secondary battery 1 may be determined to be acceptable. In some embodiments, if the calculated distance L2 exceeds the third threshold value, the secondary battery 1 may be determined to be defective. Here, the third threshold value may indicate a threshold value for the shortest distance between the center point CP and the extension line TCP extending while being separated from the center point CP. This condition may occur only in a case where there is an angular deviation between the extension line TCP and the second reference line BL2 and the intersection of the extension line TCP and the first reference line BL1 is distanced from the center point CP.

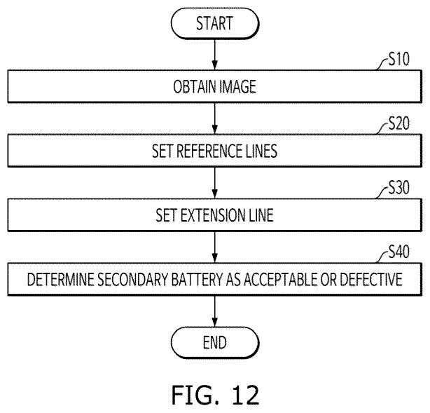

FIG. 12 illustrates a flowchart of a method for inspecting a secondary battery according to one or more embodiments of the present disclosure.

Referring to FIG. 12, in one or more embodiments of the present disclosure, the method for inspecting the secondary battery may include a step S10 of obtaining (acquiring) an image of a surface of the cap assembly 10, to which the electrode tab 30 of the secondary battery 1 is bonded, using an imaging unit 110, a step S20 of setting one or more imaginary reference lines BL1 and BL2 on the cap assembly 10 included in the image, using a processor 120, a step S30 of setting an imaginary extension line TCP extending from the electrode tab 30 included in the image, and a step S40 of determining whether the secondary battery is acceptable or defective based on a bonding state between the cap assembly 10 and the electrode tab 30 determined by using the one or more reference lines BL1 and BL2 and the extension line TCP.

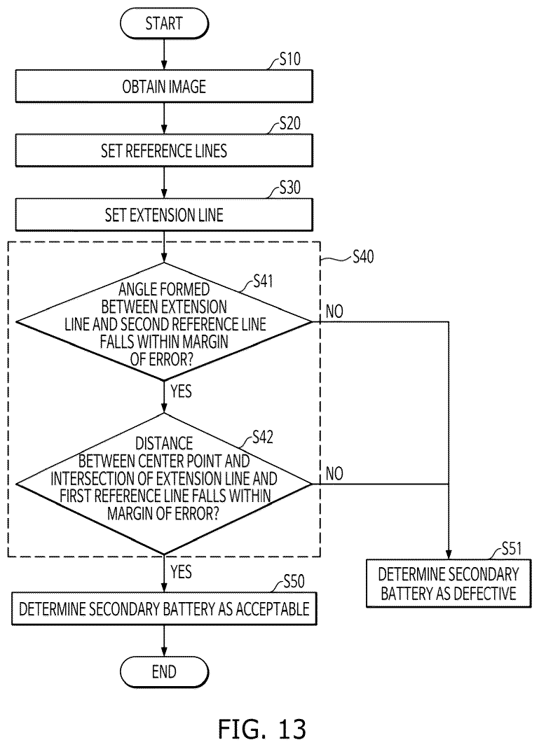

FIG. 13 illustrates a flowchart of detailed sub-steps of a step of determining whether the secondary battery is acceptable or defective according to one or more embodiments of the present disclosure.

Referring to FIG. 13, the step S40 of determining whether the secondary battery is acceptable or defective shown in FIG. 12 may include a first determination step S41 and a second determination step S42. In the first determination step S41 and the second determination step S42, it may be determined whether an angle and/or a distance measured from the obtained image falls within a margin of error.

In the first determination step S41, the processor 120 may calculate an angle formed between the extension line TCP and the second reference line BL2. Then, if the calculated angle is less than or equal to the first threshold value, the processor 120 proceeds to the second determination step S42. In some embodiments, if the calculated angle exceeds the first threshold value, the secondary battery 1 may be determined to be defective (step S51). For example, in the first determination step S41, it is determined whether the measured angle falls within the margin of error associated with the first threshold value. In this case, if the angle formed between the extension line TCP and the second reference line BL2 exceeds the first threshold value, the second determination step S42 is not performed, and the secondary battery 1 is determined to be defective.

Subsequently, in the second determination step S42, the secondary battery 1, which is determined as acceptable, may be further inspected by the processor 120 to determine whether the extension line TCP is distanced from the center point (CP) within the margin of error. In one or more embodiments, the processor 120 may calculate a distance between the center point CP and the intersection of the extension line TCP and the first reference line BL1. If the calculated distance is less than or equal to the second threshold value, the secondary battery 1 may be determined to be acceptable (step S50). In some embodiments, if the calculated distance exceeds the second threshold value, the secondary battery 1 may be determined to be defective (step S51). In another embodiment, the processor 120 may calculate the shortest distance between the extension line TCP and the center point CP. If the calculated shortest distance is less than or equal to the third threshold value, the secondary battery 1 may be determined to be acceptable. In some embodiments, if the calculated shortest distance exceeds the third threshold value, the secondary battery 1 may be determined to be defective.

In one or more embodiments, the first determination step S41 and the second determination step S42 may be executed in a reversed order.

In one or more embodiments, the first determination step S41 and the second determination step S42 may operate under parallel conditions (i.e., “or” conditions) rather than serial conditions (i.e., “and” conditions) for determining whether the secondary battery is acceptable or defective.

In one or more embodiments, either the determination of whether the second threshold value is exceeded or the determination of whether the third threshold value is exceeded may be selectively executed, or both may be executed.

The methods, processes, and/or operations described herein may be performed by code or instructions to be executed by a computer, processor, controller, or other signal processing device. The computer, processor, controller, or other signal processing device may be those described herein or one in addition to the elements described herein. The algorithms, code or instructions for implementing the operations of the method embodiments herein may transform the computer, processor, controller, or other signal processing device into a special-purpose processor for performing the methods herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, or controller which is to execute the code or instructions for performing the method embodiments described herein.

A manufacturing process of a secondary battery may include a process of electrically connecting an electrode tab of the electrode assembly to a cap assembly. When the cap assembly and the electrode tab are bonded for electrical connection, the tensile strength of the connection may vary depending on the joining condition. For instance, the electrode tab is required to be positioned to face a central portion of a jelly roll, and the secondary battery may be classified as acceptable or defective based on an angle or an alignment (orientation) of the electrode tab. Accordingly, it is prudent to inspect whether the bonding state between the electrode tab and the cap assembly has been properly completed prior to the cap assembly being joined to a can.

According to one or more embodiments of the present disclosure, based on an image capturing one surface of a cap assembly to which an electrode tab is bonded, an apparatus and a method for inspecting a secondary battery can determine the bonding state of the electrode tab.

According to one or more embodiments of the present disclosure, defective secondary batteries can be identified in advance by inspecting whether the electrode tab is correctly bonded to the cap assembly within a margin of error, using markers formed on a terminal plate or a cap plate and imaginary reference lines formed by the processor.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

DESCRIPTION OF SOME REFERENCE SYMBOLS

| | |
|---|---|
| 1: secondary battery | 10: cap assembly |
| 11: terminal | 12: terminal plate |
| 13: cap plate | 13′: marker |
| 20: case | 21: electrode assembly |
| 30: electrode tab | 100: inspection apparatus |
| 11: imaging unit | 120: processor |
| S10: image obtaining step | S20: reference line setting step |
| S30: extension line setting step | S40: determination step |
| S41: first determination step | S42: second determination step |
| S50: determined to be acceptable | S51: determined to be defective |
| ML: marking line | CP: center point |
| BL1: first reference line | BL2: second reference line |
| T11: first-1 outline | T12: first-2 outline |
| T21: second-1 outline | T22: second-2 outline |
| TCP: extension line | d1: first interval |
| d2: second interval | L: marker interval |
| A1: first threshold value | L1: second threshold value |
| L2: third threshold value | |

What is claimed is:

1. An apparatus for inspecting a secondary battery, the apparatus comprising:
an imaging unit configured to generate an image of a surface of a cap assembly to which an electrode tab of the secondary battery is bonded, resulting in a generated image; and
a processor configured to determine a bonding state of the electrode tab to the cap assembly based on the generated image, resulting in a determined bonding state,
wherein the processor is configured to:
set one or more imaginary reference lines on the cap assembly in the generated image;
set an imaginary extension line extending from the electrode tab in the generated image; and
determine whether the secondary battery is acceptable or defective based on the determined bonding state using the one or more imaginary reference lines and the imaginary extension line.

2. The apparatus as claimed in claim 1, wherein:
the cap assembly comprises a terminal plate or a cap plate including a plurality of markers at a peripheral edge of the cap plate, and
the processor is configured to set an imaginary center point on the cap assembly based on the plurality of markers.

3. The apparatus as claimed in claim 2, wherein the processor is further configured to:
set a first reference line perpendicular to a folding direction of the cap assembly, the first reference line passing through the imaginary center point; and
set a second reference line parallel to the folding direction of the cap assembly and perpendicular to the first reference line, the second reference line passing through the imaginary center point.

4. The apparatus as claimed in claim 3, wherein the processor is further configured to:
calculate an angle between the imaginary extension line and the second reference line,
determine the secondary battery as acceptable if the calculated angle is less than or equal to a first threshold value, and
determine the secondary battery as defective if the calculated angle exceeds the first threshold value.

5. The apparatus as claimed in claim 3, wherein the processor is further configured to:
calculate a distance between the imaginary center point and an intersection of the imaginary extension line and the first reference line, resulting in a calculated distance,
determine the secondary battery as acceptable if the calculated distance is less than or equal to a second threshold value, and
determine the secondary battery as defective if the calculated distance exceeds the second threshold value.

6. The apparatus as claimed in claim 3, wherein the processor is further configured to:
calculate an angle between the imaginary extension line and the second reference line, resulting in a calculated angle,
calculate a distance between the imaginary center point and an intersection of the imaginary extension line and the first reference line, resulting in a calculated distance,
determine the secondary battery as acceptable if the calculated angle is less than or equal to a first threshold value and the calculated distance is less than or equal to a second threshold value, and
determine the secondary battery as defective if the calculated angle exceeds the first threshold value or the calculated distance exceeds the second threshold value.

7. The apparatus as claimed in claim 3, wherein the processor is further configured to:
calculate a shortest distance between the imaginary extension line and the imaginary center point, resulting in a calculated shortest distance,
determine the secondary battery as acceptable if the calculated shortest distance is less than or equal to a third threshold value; and
determine the secondary battery as defective if the calculated shortest distance exceeds the third threshold value.

8. The apparatus as claimed in claim 2, wherein the processor is further configured to:
detect at least two outlines on the electrode tab included in the generated image; and
set the imaginary extension line as a centerline of the at least two outlines.

9. The apparatus as claimed in claim 2, wherein the plurality of markers includes two markers at diametrically opposite edges of the terminal plate or the cap plate.

10. The apparatus as claimed in claim 2, wherein the plurality of markers are on a surface of the terminal plate or a surface of the cap plate that has been laser irradiated.

11. A method for inspecting a secondary battery, the method comprising:
obtaining, by an imaging unit, an image of a surface of a cap assembly to which an electrode tab of the secondary battery is bonded;
setting, by a processor, one or more imaginary reference lines on the cap assembly included in the image;
setting, by the processor, an imaginary extension line extending from the electrode tab included in the image; and
determining, by the processor, whether the secondary battery is acceptable or defective based on a bonding state determined, by the processor, using the one or more imaginary reference lines and the imaginary extension line.

12. The method as claimed in claim 11, wherein the cap assembly comprises a terminal plate or a cap plate including a plurality of markers formed at a peripheral edge of the cap plate, and
the method further comprises setting, by the processor, an imaginary center point on the cap assembly based on the plurality of markers.

13. The method as claimed in claim 12, wherein setting one or more imaginary reference lines comprises:
setting, by the processor, a first reference line that is perpendicular to a folding direction of the cap assembly and passes through the imaginary center point; and
setting, by the processor, a second reference line that is parallel to the folding direction of the cap assembly and perpendicular to the first reference line, the second reference line passing through the imaginary center point.

14. The method as claimed in claim 13, wherein determining whether the secondary battery is acceptable or defective comprises:
calculating, by the processor, an angle between the imaginary extension line and the second reference line, resulting in a calculated angle,
determining, by the processor, the secondary battery as acceptable if the calculated angle is less than or equal to a first threshold value, and
determining, by the processor, the secondary battery as defective if the calculated angle exceeds the first threshold value.

15. The method as claimed in claim 13, wherein determining whether the secondary battery is acceptable or defective comprises:
calculating, by the processor, a distance between the imaginary center point and an intersection of the imaginary extension line and the first reference line, resulting in a calculated distance,
determining, by the processor, the secondary battery as acceptable if the calculated distance is less than or equal to a second threshold value; and
determining, by the processor, the secondary battery as defective if the calculated distance exceeds the second threshold value.

16. The method as claimed in claim 13, wherein determining whether the secondary battery is acceptable or defective comprises:
calculating, by the processor, an angle formed between the imaginary extension line and the second reference line, resulting in a calculated angle,
calculating, by the processor, a distance between the imaginary center point and an intersection of the imaginary extension line and the first reference line, resulting in a calculated distance,
determining, by the processor, the secondary battery as acceptable if the calculated angle is less than or equal to a first threshold value and the calculated distance is less than or equal to a second threshold value, and
determining, by the processor, the secondary battery as defective if the calculated angle exceeds the first threshold value or the calculated distance exceeds the second threshold value.

17. The method as claimed in claim 13, wherein determining whether the secondary battery is acceptable or defective comprises:
calculating, by the processor, a shortest distance between the imaginary extension line and the imaginary center point, resulting in a calculated shortest distance;
determining, by the processor, the secondary battery as acceptable if the calculated shortest distance is less than or equal to a third threshold value; and
determining, by the processor, the secondary battery as defective if the calculated shortest distance exceeds the third threshold value.

18. The method as claimed in claim 12, wherein setting the imaginary extension line comprises detecting, by the processor, at least two outlines on the electrode tab included in the image; and setting, by the processor, the imaginary extension line being a centerline of the at least two outlines.

19. The method as claimed in claim 12, wherein the plurality of markers include two markers formed at diametrically opposite edges of the terminal plate or the cap plate.

20. The method as claimed in claim 12, wherein the plurality of markers are formed on a surface of the terminal plate or a surface of the cap plate by a laser irradiation device.
